(19) United States
(12) Patent Application Publication
(10) Pub. No.: US 2017/0238557 A1
(43) Pub. Date: Aug. 24, 2017

(54) AQUEOUS COMPOSITION BASED ON NATURAL EXTRACTS FOR CLEANING, AND AS A DISINFECTANT, INSECT REPELLENT, INSECTICIDE AND FRESHENER

(71) Applicant: Adela Monica Buljubasich Murillo, Guayaquil (EC)

(72) Inventor: Adela Monica Buljubasich Murillo, Guayaquil (EC)

(21) Appl. No.: 15/504,569

(22) PCT Filed: Aug. 26, 2015
(86) PCT No.: PCT/IB2015/056447

§ 371 Date: Feb. 16, 2017

(30) Foreign Application Priority Data
Sep. 2, 2014 (PE) 001349-2014/DIN

(51) Int. Cl. A01N 65/28; A01N 33/12; A01N 25/22; A01N 25/30; A01N 59/14; A01N 25/04; C11D 1/62; C11D 3/40; C11D 3/48; C11D 3/50; C11D 3/382; C11D 3/22; C11D 3/20; C11D 3/33; C11D 3/04; C11D 1/66; A01N 65/22

(52) U.S. Cl. CPC A01N 65/28; A01N 65/22; A01N 33/12; A01N 25/22; A01N 25/30; A01N 59/14; A01N 25/04; C11D 1/62; C11D 3/40; C11D 3/48; C11D 3/50; C11D 3/382; C11D 3/225; C11D 3/2065; C11D 3/33; C11D 3/042; C11D 1/662

(57) ABSTRACT

The invention provides a biodegradable aqueous composition based on natural extracts (natural essences and essential oils), quaternary ammonium, propylene glycol, Cellocize, EDTA, Tween 80, boric acid, aromas, colorants and water, for cleansing, disinfecting as an antiseptic and possessing a broad-spectrum bactericidal activity, ie bactericidal at once on gram positive and gram negative bacteria; also as an insecticide or at least as an insect repellent and as a freshener.

### BACKGROUND

Cleaning compositions are commercially important products and satisfy a wide range of utilities helping to remove dirt and grime from all types of surfaces; these compositions generally contain fresheners; it is also important to maintain environments with a pleasant aroma, free from pathogenic microorganisms and harmful insects, and it is necessary to use fresheners, disinfectants and insecticides to eliminate them or at least to repel insects.

The need to control urban pests is obvious and we believe that it does not need special justification. Suffice it to recall that the lack of hygiene and the lack of control of rats in medieval cities triggered the bubonic plague epidemic that killed a third of the European population or that cockroaches are vectors in the spread of cholera, to conclude that it is necessary to activate such control. There is no doubt about its urgency; the only possible discussion is about the best way to do it.

We have to remember that a pesticide is a bound pollutant. That is, in other activities, pollution is an accident or an act of irresponsibility. In contrast, the application of pesticides is an act of deliberate contamination, by which toxic substances are incorporated into the environment. These are substances whose aim is to destroy living beings, which means that they can not be innocuous for people, despite what advertising refers to sectoral interests. However, the fiction that insecticides do not harm human beings is routinely handled among us and the necessary precautions are not taken to prevent such damages.

For years the industry has used highly toxic components for humans, domestic animals and ecosystems, an easy way to earn money without looking for alternatives that could have the least cost to life on earth. It is stated, for example, that most pesticides used in environmental health pose serious human health hazards. But pesticides are often very volatile products and also intoxicated by inhalation. This makes the frequency of damage to human health high, and also requires greater care than with other substances, whose level of toxicity in the tables seems similar. Today, people with no knowledge of the toxicological risks of these substances apply them in their homes and fumigate their kitchens, and almost always with products of carcinogenic residual effects that are often prohibited in their countries of origin. These people leave toxic waste in their dishes, which they then use, or in food cans, in tanks or cupboards where we store spices and products as flour, or in toys displayed. In commercial stores where food products are sold in bulk like rice, sugar and other products, these products come highly contaminated to the people we most want to be our family. Our children end up suffering from various types of allergies, especially the respiratory ones. Our pets are poisoned because they consume the remains of things that are contaminated. In the case of insecticides taking as reference the most famous are Baygon® that has between its components Cypermethrin and Imiprotrin; Raid® which has among its components Cypermethrin, Imiprotrin, α-cyano-3-phenoxybenzyl-2,2, Dichlorovinyl, Cyclopropane carboxylate, Imidazolidin-methyl, Chrysanthemat; And DRAGON®, which has between its components Cypermethrin and Tetramitrin; we can verify that they are highly toxic and are not biodegradable.

In fact, the safety sheets of these products tell us about active components that are not highly biodegradable, so they remain in the environment, we must also recognize that they do not directly attack the nests of these insects if not just one Superficial way; But with worse evil, insects have become resistant to these anti-natural products, and are increasingly forced to use more aggressive components that we do not know how they will affect humans and animals.

Therefore, the aforementioned products are effective products such as pesticides or insecticides but are also highly toxic and very dangerous for humans, animals and the environment.

In fact, Imiprotrin is a synthetic insecticidal pyrethroid. It is an ingredient in some insecticide products for home use. It has little acute toxicity in humans, but in insects it acts as a neurotoxin causing paralysis. It presents the following risks:
Harmful by inhalation, in contact with skin and if swallowed.
Very toxic to aquatic organisms, it may cause long-term adverse effects in the aquatic environment.
Skin: Irritation, burns, itching, rashes and redness.
Inhalation: Irritation of the nose, throat and lung with cough, wheezing and shortness of breath, headache, dizziness, tiredness, muscle weakness, nausea and vomiting.

For its part, cypermethrin has become one of the most important insecticides for large-scale use. Cypermethrin acts as a stomach and contact insecticide. It has wide uses in cotton, cereals, vegetables and fruits, for food storage, public health and animal husbandry. Its structure is based on pyrethrum, a natural insecticide that is contained in chrysanthemum flowers, but has a higher biological activity and is more stable than its natural model. It was synthesized in 1974 and introduced to the market in 1977 by Shell (which has since sold its production of pesticides to American Cyanamid).

Cypermethrin is classified by the World Health Organization (WHO) as “moderately harmful” (class II). It interacts with the sodium channels in the nerve cells through which sodium enters the cell to transmit a nerve signal. These channels can remain open for seconds unlike the normal few thousandths of a second, after signal transmission. Cypermethrin also interferes with other receptors in the nervous system. The resulting effect is a long sequence of repetitive pulses in the sensory organs.

Symptoms of poisoning include abnormal facial sensations, dizziness, headache, nausea, anorexia and fatigue, vomiting and increased stomach secretion. Cypermethrin is also an irritant to the skin and eyes. Symptoms should usually appear after a few days, but severely exposed patients may also experience muscle spasms and seizures. In such cases, the symptoms may persist for several weeks.

Chronic symptoms have been reported after contact with pyrethroids. The symptoms included are brain and locomotor disorders, polyneuropathy and immunological suppressions, which also resemble multiple chemical sensitivity syndrome (MCS).

Pyrethroids are widely used because of their low overall toxicity to birds and mammals. However, they are highly toxic to aquatic organisms and to fish as well as to bees—with the same intensity of action in each organism. LC 50 values for small fish and other aquatic organisms are generally below 1 mg/L, and the LD 50 value for bees is 0.03-0.12 mg per bee. For use with conventional hydraulic sprinklers, it is necessary to have areas of tolerance of 16-24 m to reduce the mortality of the butterflies in the surroundings.

After domestic use, the cypermethrin residues can be found in the dust and carpet at a concentration of up to 4 mg/kg 16. The concentration in the air after domestic treatments increases rapidly, and may remain relatively constant during Months at levels at which pyrethroids may cause adverse health effects (3-8 mg/m3).

Recent studies show that the effects of cypermethrin on health, and pyrethroids in general, may be more severe than was suggested in previous toxicological assessments. Further studies on carcinogenicity and chronic toxicity are required.

Ideal characteristics of an insecticide are:

1. Great specificity. The product only affects the organism it damages, leaving the rest of living beings and the environment free.

2. Low toxicity in humans. The product is at low risk for both acute poisoning and low dose exposures. Low toxicity for rest of fauna. Its toxicity is usually contemplated for freshwater fauna and pollinating fauna (bees).

3. Low dose lethal. The insecticide is effective with little quantity.

4. Low cost. The product has to be inexpensive cheap.

5. Latent feature The insecticide remains in place for a period of time sufficient to interact and kill the pest constituent population to combat. But . . .

Not persistent or cumulative. It must degrade without producing toxic byproducts, ie not being persistent or accumulating in the tissues of animals in the food chain after having acted.

Obviously these characteristics are rarely present in the same product.

In order to reduce the use of high toxicity insecticides or pesticides that are harmful to humans, animals and the environment, and at the same time to clean, disinfect and freshen the environment, particularly for use in homes and offices; by means of the requested one proposes a biodegradable aqueous compound based on natural extracts that is an efficient institutional grade cleaner, for the cleaning of any surface washable with water and that removes dirt from floors, furniture, plastic or vinyl surfaces, painted walls, doors, etc., and its natural extracts contribute as an excellent insect repellent, which neutralizes pests of crawling and flying insects and also provides a pleasant aroma. It is no longer necessary to use several products; ie, a disinfectant, an insecticide, a repellent or insecticide, and a freshener; on the contrary, a single product is used that provides the same benefits as the use of four products.

### BRIEF DESCRIPTION OF THE INVENTION

The invention provides a biodegradable aqueous composition based on natural extracts (natural essences and essential oils), quaternary ammonium, propylene glycol, Cellocize, EDTA, Tween 80, boric acid, aromas, colorants and water, for cleaning, disinfection, insecticide or repellent and as a freshener.

It uses natural products combined with chemical components that are currently used, but at just and necessary percentages achieving the perfect blend needed to perform effective cleaning at home, repelling certain insects and killing others, but still a product Biodegradable that will be in place just enough time to end these pests.

The invention provides a product which disinfects the areas, is bactericidal, repels certain insects and kills others. It helps control pests such as flies, cockroaches, ants, wasps, and natural scents.

### DESCRIPTION OF THE INVENTION

The present invention relates to a biodegradable aqueous composition based on natural extracts (natural essences and essential oils), quaternary ammonium, propylene glycol, Cellocize, EDTA, Tween 80, boric acid, aromas, colorants and water, for cleaning, disinfection as an antiseptic and which possesses broad-spectrum bactericidal activity, ie bactericidal at once on gram positive and gram negative bacteria; also as an insecticide or at least as an insect repellent, and as a freshener.

According to the present invention there is formulated a composition having properties for cleaning, disinfection, insecticide or repellent and as a freshener, based on natural essences, particularly those present in mint and clove essential oils, combined with acid boron, quaternary ammonium, and other products to facilitate their combination or mixing and cleaning surfaces. Propylene glycol is used as a stabilizer, solvent for chemicals, dyes and aromas; particularly, it is used in liquid detergents in support of hygienic conditions. Cellocize is used as a thickening agent. Ethylene diamine tetraacetic acid, also called EDTA or less commonly AEDT, is a substance that is used as a chelating agent to create complexes with heavy metal ions. TWEEN 80 which is a Nonionic surfactant or surfactant, also known as Polysorbate 80 N.F., or Polyoxyethylene Sorbitan Monooleate 80.

Finally, water is added in the amount necessary and sufficient to obtain an aqueous composition of the invention.

Throughout this specification and the appended claims, the percentages by weight of any constituent should be understood as the percentage by weight of the active portion of the referred constituent, unless otherwise indicated.

The compounds used in the formulation of the composition of the present invention will now be briefly described.

a) Essential Oils

1. Peppermint oil is known for its effects as a bactericide and as an antiseptic. There is no exact composition formula since the percentage of each component may vary depending on the conditions of culture and collection of the plant as well as the extraction or distillation process. The main substances that we can find in essential oil of mint and its proportions are:
Menthol with 30-55%;
Mentone 14-32%;
Methyl acetate 2.8-10%;
Isomentone 1.5-10%;
Mentofuran: 1-9%;
Cineol: 3.5-14%;
Limonene: 1-5%;
Isopulegol: up to 0.2%; and
Carvone: up to 1%.

2. Among the main active compounds of clove essential oils are:
Eugenol;
Acetilenglenol;
Caryophyllene;
Pinenools entone;
Caryophylline Menthyl;
Icilato methyl;
Tannins;
Mucilages;
Phytosterols; and
Entrofuran.

b) Quaternary Ammonium

Quaternary ammonium compounds represent a family of antimicrobial compounds, which are considered to be potent cationic active agents in their disinfecting activity, since they are active to eliminate gram-negative and gram-negative bacteria, although the latter to a lesser degree are bactericidal, fungicidal and virucidal. Its activity is developed on both the acid and alkaline medium, although in the latter, better actions are compatible with cationic, nonionic and amphoteric actives. They are generally colorless or yellowish, non-irritating and deodorant. Due to their chemical structure at low temperatures they tend to “freeze” but recover their liquid state by warming them. They also have a detergent action and are soluble in water and alcohol. They have as basic structure the ammonium ion (NH4), which when modified, gives rise to different generations. Second-generation quaternary ammonium compounds (ethylbenzyl chloride) and third generation (first and second generation ie Benzalkonium Chloride and Alkyl Dimethyl Ethyl Benzyl Ammonium Chloride) compounds are compounds that remain most active in the presence of water hard.

Its bactericidal action is attributed to inactivation of enzymes, denaturation of essential proteins and the breakdown of the cell membrane. They are usually considered as disinfectants at concentrations of 0.25% to 1.6% for the disinfection of surfaces such as floors and walls. The third generation quaternaries have an increase in biocidal activity, increased detergency and an increase in bacterial resistance to the constant use of a single molecule. Fourth-generation quaternary ammonium compounds called quaternary “Twin or Dual Chain Quats” are quaternary products with linear dialkyl chains and without benzene ring, such as: Didexyl Dimethyl Ammonium Chloride or Dioctyl Dimethyl Ammonium Chloride or Octyl Decil Ammonium Chloride, each isolated. These quaternaries are superior in how much germicidal activity; they are of low foam and have a high tolerance to the loads of protein and the hard water.

They are recommended for disinfection in the food and beverage industry, as they can be applied due to their low toxicity. Finally, the fifth generation quaternary ammonium compounds are fourth generation blends with the second generation, ie: didecyl dimethyl ammonium chloride+alkyl dimethyl benzyl ammonium chloride+alkyl dimethyl ethyl benzyl ammonium chloride + . . . other varieties According to the formulations. The fifth generation has a higher germicidal performance under hostile conditions and is safe to use.

c) Propylene Glicol

Propylene glycol (propane-1,2-diol) is an organic compound (an alcohol, more precisely a diol) that is obtained by hydration of the propylene oxide. Propylene Glycol is a clear oily liquid, slightly viscous at room temperature, hygroscopic, colorless, tasteless and odorless, and miscible with water, acetone, and chloroform. Propylene Glycol has had an unparalleled reputation for safe use in a wide range of consumer products, including food products, animal feed, cosmetics and pharmaceuticals, as well as in industrial applications. It is used as a stabilizer, solvent in chemicals, dyes and aromas. Particularly, it is used in liquid detergents in support of hygienic conditions.

d) Cellosize

Cellocize is a compound that is used as a thickening agent that when added to a mixture increases its viscosity without substantially modifying its other properties such as freshener, etc. Provides body, increases stability and facilitates the formation of suspensions.

e) EDTA

Ethylene diamine tetraacetic acid, also called EDTA or less commonly AEDT, is a substance used as a chelating agent that can create complexes with heavy metal ions.

f) TWEEN 80

It is a non-ionic surfactant or surfactant, also known as polysorbate 80 NF, or polyoxyethylene sorbitan monooleate 80. It is a yellow to amber liquid, used for emulsification of oil in water (O/W), dispersion or solubilization Of oils, and to make anhydrous ointments washable. Tween 80 is often combined with SPAN 80 surfactant to promote emulsion stability.

g) Boric Acid

Boric acid was first recorded in the USA as insecticide in 1948 for the control of cockroaches, termites, ants, fleas, silverfish, and many other insects. The product is generally considered safe for use in home kitchens to control cockroaches and ants. It acts as a stomach poison that affects the metabolism of insects, and dry powder is abrasive to the exoskeleton of insects.

The invention provides a biodegradable aqueous composition based on natural extracts (natural essences and essential oils), quaternary ammonium, propylene glycol, Cellocize, EDTA, Tween 80, boric acid, aroma, colorants and water, which provides a cleaning benefit, a benefit of disinfectant, an insecticide or repellent and a freshener consisting of the following constituents:

Each 100% w/w, v/v contains:

| | |
|---|---|
| Natural Essences | 0.3-0.6% |
| (Peppermint Essential Oil, Clove Oil) | |
| Quaternary Ammonium | 0.1-0.3% |
| Propylene glycol | 0.1-0.3%, |
| Cellocize | 0.05-0.20% |
| EDTA | 0.02-0.07%, |
| Tween 80 | 0.1-0.3%, |
| Boric Acid | 0.1-0.3%, |
| * Aroma | 0.1-0.3% |
| ** Colorants | 0.01-0.05%, |
| Water q.s.p | 100.00% |

* Lavender, passion fruit, coconut, patchouli and potpourri, mint, melon, lemon, gardenia-oriental wood, sandal-jasmine, - mandarin, green tea, eucalyptus, guava, orange-banana, oriental wood, orange-mango, mango.
** Violet Light FD & C Variety Lavender

Orange FD & C Maracuya variety.

Amarillo Tenue FD & C #5 (0.005%) Coconut and Chamomile variety.

White FD & C #5 (0.005%) Variety eucalyptus

Café Claro FD & C Variety Potpourri and Patchouli

Green FD & C Variety Mint

Green FD & C Lemon variety

Rosado FD & C Variety Guayaba

Orange FD & C Orange-Banana Variety

Orange Intense FD & C Variety Mandarin

Orange FD & C Variety Melon

Red Orange FD & C Variety Oriental Wood

Intense Orange FD & C Variety Gardenia-Oriental Wood

Orange Clear FD & C Sandalwood Variety-Jasmine

Slightly Orange Orange FD & C Variety Orange-Mango

Yellow Green FD & C Green Tea Variety

Yellow FD & C Variety Mango.

### ADVANTAGES OF THE INVENTION

The preferred composition according to the invention is largely aqueous, and comprises at least 80% by weight of water, and can be easily poured and pumped. The composition shows good storage stability.

The aqueous composition may be used in a process for cleaning or sanitizing surfaces, such as insecticide or insect repellent, and further as a freshener, comprising providing the composition as described above, and applying an effective amount to an environment where it is required its treatment.

The aqueous composition according to the invention is desirably provided as a ready-to-use product which can be applied directly.

The aqueous composition according to the invention may be desirably provided as a ready-to-use product in manually operated spray delivery containers, or may be provided as aerosol type products discharged from a pressurized aerosol container. Propellants known in the art, such as liquid propellants based or propellants in the non-liquid form, ie, pressurized gases, including air, nitrogen, and others may be used.

While the composition of the present invention is designed for use in the types of liquid forms described above, nothing in this specification will be construed as limiting the use of said composition with an additional amount of water to form a cleaning solution.

The aqueous composition according to the invention allows the provision in a single product of a disinfectant with broad bactericidal action, a cleaner of all kinds of surfaces, an insecticide or insect repellent and a freshener with essential oils, in addition to being biodegradable.

### EVALUATION OF COMPOSITION

In the following tables, the results of tests performed to demonstrate its disinfecting activity as an antimicrobial agent, as an insecticide to eliminate flying insects such as the common fly; as insecticide against crawling insects such as the drain cockroach; and against the common black ant.

The biodegradable composition based on natural extracts (natural essences and essential oils), quaternary ammonium, propylene glycol, Cellocize, EDTA, Tween 80, boric acid, aromas, dyes and colorants can be asserted from the results shown in each of the tests carried out. Water is very effective for cleaning which is complemented by the excellent antimicrobial efficacy against known bacteria commonly found in bathrooms, kitchens and other environments as well as insecticide or insect repellent and as a freshener.

1-3. (canceled)

4. Biodegradable aqueous composition based on natural extracts CHARACTERIZED because it consists of a stable composition of cleaning, disinfection, insect repellent, insecticide and freshener, comprising: (i) 0.3-0.6% peppermint essential oil and clove oil; (ii) 0.1-0.3% quaternary ammonium; (iii) 0.1-0.3% propylene glycol; (iv) 0.05-0.20% Cellocize; (v) 0.02-0.07% EDTA; (vi) 0.1-0.3% Tween 80; (vii) 0.1-0.3% boric acid; (viii) 0.1-0.3% aroma; (ix) 0.01-0.05% of dyes; and (x) 80-100.00% water q.s.

5. Aqueous composition according to claim 1, CHARACTERIZED because the aromatic compounds are lavender, passion fruit, chamomile, coconut, patchouli and potpourri, mint, melon, lemon, oriental gardenia-wood, sandal-jasmine,—mandarin, green tea, eucalyptus, Guava, orange-banana, oriental wood, orange-mango, mango.

6. Aqueous composition according to claim 1, CHARACTERIZED because the coloring compounds are Violet Light FD&C Variety Lavender, Orange FD&C Variety Maracuya, Fuchsia Yellow FD&C #5 (0.005%) Coconut and Chamomile Variety, White FD&C #5 (0.005%) Eucalyptus variety, FD&C Variety Potpourri and Patchouli, Green FD&C Variety Mint, Green FD&C Variety lemon, FD&C Variety Guava, Orange FD&C Variety Orange-Banana, Deep Orange FD&C Variety Mandarin, Light Orange FD&C Variety Melon, Intense Orange FD&C Variety Gardenia-Orient Wood, Light Orange FD&C Variety Sandalwood-Jasmine, slightly orange Orange FD&C Variety Orange-Mango, Yellow Green FD&C Variety Green Tea, and Yellow FD&C Variety Mango.
